(19) United States
(12) Patent Application Publication
(10) Pub. No.: US 2006/0185103 A1
(43) Pub. Date: Aug. 24, 2006

(54) Novel reactive dye composition with three-color combination

(76) Inventors: Sung Yong Cho, Seoul (KR); Woo Jin Yoon, Seoul (KR); Sang Ki Yang, Seoul (KR)

Correspondence Address: CANTOR COLBURN, LLP, 55 GRIFFIN ROAD SOUTH, BLOOMFIELD, CT, 06002, US

(21) Appl. No.: 11/339,034

(22) Filed: Jan. 25, 2006

(30) Foreign Application Priority Data
Jan. 25, 2005 (KR) 10-2005-0006617

(51) Int. Cl. C09B 62/20

(52) U.S. Cl. 8/549

(57) ABSTRACT

Provided is a reactive dye composition, comprising (i) a reactive red dye represented by Formula 1; (ii) one or more reactive dyes selected from the group consisting of a reactive yellow dye represented by Formula 2, a reactive orange dye represented by Formula 3 and a mixture thereof; and (iii) one or more reactive dyes selected from the group consisting of a reactive blue dye represented by Formula 4, a reactive blue dye represented by Formula 5 and a mixture thereof; and a method of dyeing a fiber material containing nitrogen or hydroxyl group using the same. Therefore, it is possible to provide fiber products having superior light fastness and combined colors.

### BACKGROUND OF THE INVENTION

1. Field of the Invention

The present invention relates to a novel reactive dye composition with three-color combination.

2. Description of the Related Art

As a conventional technique for three-color combination dyeing using a reactive dye, there is known a method using combination of a red dye such as C.I. Reactive Red 195 or C.I. Reactive Red 180 and yellow and blue dyes. In this case, the yellow and blue dyes exhibit excellent light fastness, but the red dye has suffered from problems associated with exhibiting physical properties which are required in dyeing. Recently, in dyeing materials using the reactive dyes, with increasing demand for light fastness by consumers, use of conventional reactive red dyes cannot keep pace with such requirements. As such, there is a need for development of a red dye having high fastness against light.

C.I. Reactive Red 195:

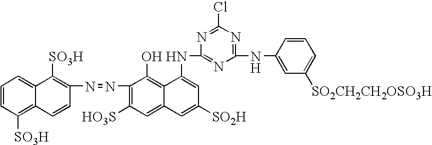

C.I. Reactive Red 180:

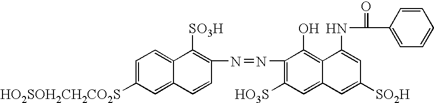

### SUMMARY OF THE INVENTION

Therefore, the present invention has been made to solve the above problems, and other technical problems that have yet to be resolved.

As a result of a variety of extensive and intensive studies and experiments to solve the problems as described above, the inventors of the present invention have developed, as will be described hereinafter, a reactive red dye having superior fastness against light and moisture upon dyeing a fiber material and have discovered that combination dyeing using the above-developed dye enables provision of a fiber product having superior light fastness and a high-quality combined color. The present invention has been completed based on these findings.

In accordance with an aspect of the present invention, the above and other objects can be accomplished by the provision of a reactive dye composition, comprising

(i) a reactive red dye represented by Formula 1;

(ii) one or more reactive dyes selected from the group consisting of a reactive yellow dye represented by Formula 2, a reactive orange dye represented by Formula 3 and a mixture thereof; and

(iii) one or more reactive dyes selected from the group consisting of a reactive blue dye represented by Formula 4, a reactive blue dye represented by Formula 5 and a mixture thereof.

The reactive dye-based composition in accordance with the present invention exhibits superior adsorptivity and fixability when dyeing a fiber material containing nitrogen or hydroxyl group, particularly a cellulose fiber material, and particularly very high light fastness and thus provides a variety of balanced physical properties which are required in dyeing.

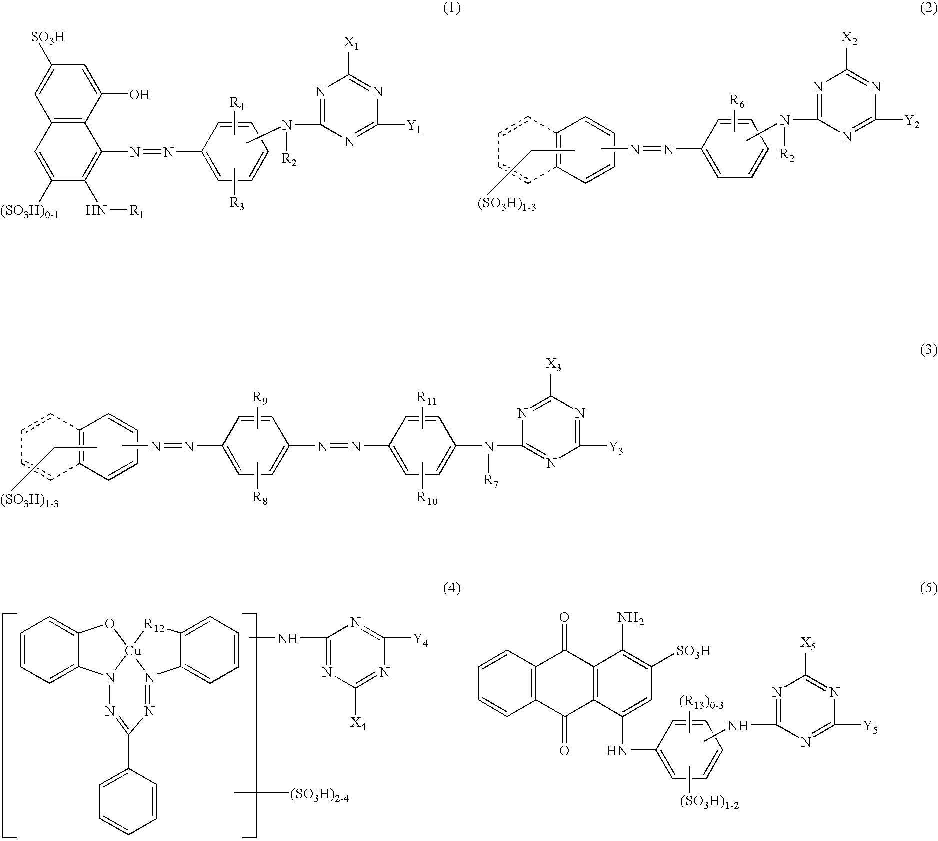

wherein:

R1, R2, R5 and R7 are independently hydrogen, or C1-C4 alkyl which may be substituted or unsubstituted with hydroxyl, sulfo, sulfato or carboxyl group;

R3, R4, R6, R8, R9, R10, R11 and R13 are independenty hydrogen, C1-C4 alkyl, C1-C4 alkoxy, C2-C4 alkanoylamino, ureido, sulfamoyl, halogen, sulfo or carboxyl group;

R12 is hydroxyl, sulfo or carboxyl group;

Y1, Y2, Y3, Y4 and Y5 are independently a substituent group of Formula 6a, 6b or 6c: 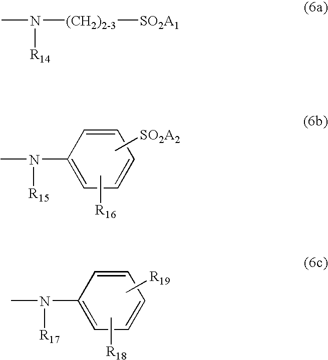
wherein R14, R15 and R17 are independently hydrogen, or C1-C4 alkyl which may be substituted or unsubstituted with hydroxyl, sulfo, sulfato or carboxyl group; R16, R18 and R19 are independently hydrogen, C1-C4 alkyl, C1-C4 alkoxy, C2-C4 alkanoylamino, ureido, sulfamoyl, halogen, sulfo or carboxyl group; A1 and A2 are independently a vinyl group or a radical of —CH2-CH2-Q, wherein Q is a leaving group that can be removed under alkaline conditions, for example —Cl, —Br, —F, —OSO3H, —SSO3H, —OCO—CH3, —OPO3H2, —OCO—C6H5, —OSO2-C1-C4 alkyl or —OSO2N(C1-C4 alkyl), preferably —OSO3H; and

X1, X2, X3, X4 and X5 are independently a substituent group of Formula 6a, 6b or 6c, which is an N-heterocyclic group capable of further containing halogen, hydroxyl, 3-carboxypyridin-1-yl, 3-carbamoylpyridin-1-yl, C1-C4 alkoxy group, C1-C4 alkylthio group, unsubstituted or substituted amino group, or a hetero atom.

A dye ratio between the dye components (i), (ii) and (iii) in the composition may vary depending on a desired dyeing concentration.

Upon dyeing of the dye components (i), (ii) and (iii), a mixing ratio therebetween may be in a range of 0.1 to 99.9:0.1 to 99.9:0.1 to 99.9 and preferably 1 to 99:1 to 99:1 to 99.

### DESCRIPTION OF THE PREFERRED EMBODIMENTS

Hereinafter, the present invention will be described in more detail.

Preferred examples of a reactive red dye of Formula 1 in accordance with the present invention may include compounds represented by Formulae 7, 8 and 9:

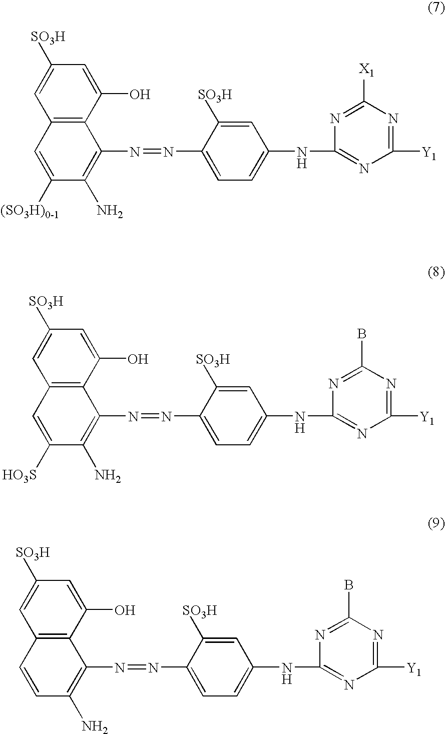

wherein X1 and Y1 are as defined in Formula 1; and

B is a substituent group of Formula 6a, 6b or 6c, provided that fluorine and chlorine are excluded unlike X1 in Formula 1.

The reactive red dye of Formula 1 in accordance with the present invention may be prepared via reaction involving many steps of condensation, and a preferred example of such a method includes the following reaction steps:

(1) condensing a compound of Formula 6a or 6b, or the following Formula 10 with 2,4,6-trihalogeno-s-triazine, thereby preparing a compound of the following Formula 11 or 12;

(2) condensing a compound of the following Formula 11 or 12 with a compound of Formula 6a, Formula 6b or the following Formula 10, thereby preparing a compound of the following Formula 13; and

(3) condensing the compound of Formula 13 prepared in step (2) with the compound of Formula 6c, thereby preparing a compound of Formula 1.

Unless otherwise specified, R1, R2, R3, R4, X1 and Y1 in Formulae 1, 10, 11, 12 and 13 are as defined in Formulae 1, 10, 11, 12 and 13.

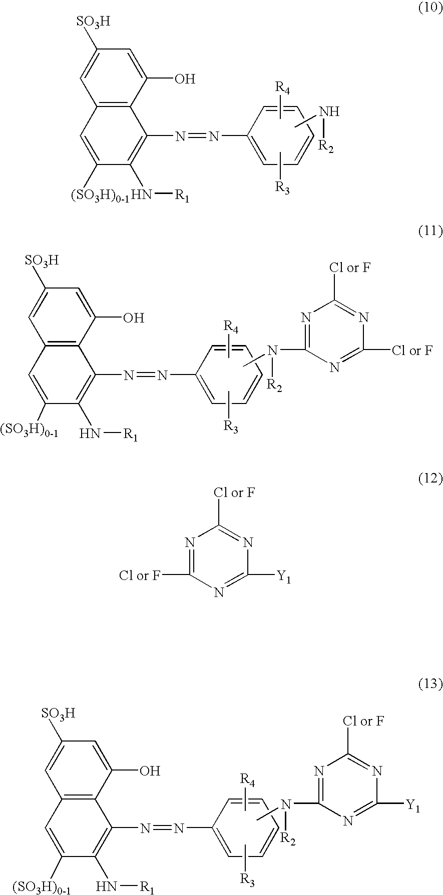

Condensation (1) may be carried out in an organic medium, an aqueous medium, or an aqueous-organic medium, and is preferably carried out in the aqueous medium in the presence of an acid-binding agent. Preferred examples of the acid-binding agent may include carbonates, bicarbonates and hydroxides of alkali metals, carbonates, bicarbonates and hydroxides of alkaline earth metals, alkali metal acetates and mixtures thereof, and tertiary amines. Preferred examples of the alkali metals and alkaline earth metals may include lithium, sodium, potassium and calcium. Preferred examples of the tertiary amines may include pyridine, triethylamine and quinoline. Condensation (1) is carried out at a temperature of −10 to 40° C. and more preferably 0 to 10° C. and a pH of 1.0 to 9.0.

Similar to condensation (1), condensation (2) may also be carried out in an organic medium, an aqueous medium, or an aqueous-organic medium, and is preferably carried out in the aqueous medium in the presence of an acid-binding agent. Condensation (2) is carried out at a temperature of 10 to 70° C. and a pH of 2.0 to 9.0, and more preferably is carried out at a temperature of 20 to 60° C. and a pH of 2.0 to 8.0.

Further, similar to condensation (1), condensation (3) may also be carried out in an organic medium, an aqueous medium, or an aqueous-organic medium, and is preferably carried out in the aqueous medium in the presence of an acid-binding agent. Condensation (3) is carried out at a temperature of 50 to 100° C. and a pH of 1.0 to 9.0, and more preferably is carried out at a temperature of 20 to 60° C. and a pH of 2.0 to 5.0.

In addition to the above-mentioned methods, various methods for preparing the dye compound of Formula 1 can be employed. Those of ordinary skill in the art will apparently appreciate such methods through the methods as discussed above, without specific details thereof.

The reactive dye composition in accordance with the present invention may further optionally include a compound of Formula 14:

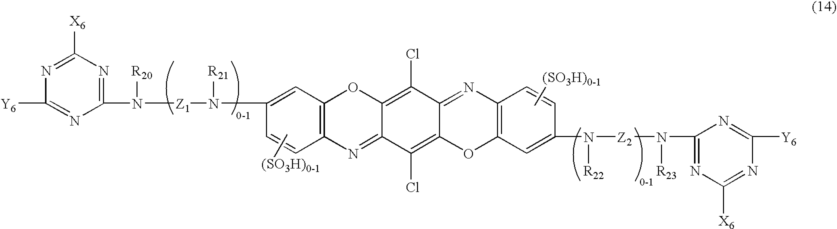

wherein R20, R21, R22 and R23 are independently hydrogen, or C1-C4 alkyl which may be substituted or unsubstituted with hydroxyl, sulfo, sulfato or carboxyl group;

Y6 is a substituent group of Formula 6a, 6b or 6c;

X6 is a substituent group of Formula 6a, 6b or 6c, which is an N-heterocyclic group capable of further containing halogen, hydroxyl, 3-carboxypyridin-1-yl, 3-carbamoylpyridin-1-yl, C1-C4 alkoxy group, C1-C4 alkylthio group, unsubstituted or substituted amino group, or a hetero atom; and

Z1 and Z2 are independently unsubstituted or substituted C2-C10 alkylene.

The dye composition in accordance with the present invention is suitable as a dye for dyeing a fiber material containing nitrogen or hydroxyl group. Such a fiber material that can be used in the present invention includes, for example natural cellulose fibers such as cotton, flax and hemp, pulp and recycled cellulose. Particularly preferred is cotton. The combination in accordance with the present invention is also suitable for dyeing a cellulose blended fabric, for example cotton/polyester, cotton/nylon blended fabric and the like.

An amount of the dye composition to be used may vary depending on a degree of desired coloration. The dye composition in accordance with the present invention may be used in an amount of 0.01 to 10% by weight, and preferably 0.01 to 6% by weight, based on the fabric to be dyed.

The dye composition in accordance with the present invention is particularly suitable for dyeing via an exhaustion method.

The exhaustion method of dyeing is usually carried out in an aqueous medium, at a reaction temperature of 20 to 105° C., preferably 30 to 90° C. and more preferably 40 to 80° C., using the dye and water in a weight ratio of 1:2 to 1:60 and preferably 1:5 to 1:20.

Alternatively, other suitable dyeing methods such as pad dyeing may be used. In pad dyeing, a fabric is typically impregnated and reacted in an aqueous solution, saline or a salt solution. Here, the pick-up rate is in a range of 20 to 150%, preferably 50 to 100%, based on the weight of the fiber material to be dyed. The aqueous solution may contain a fixing alkali in advance, or if necessary, the fiber material may be treated with the fixing alkali after impregnation. Examples of suitable alkali metals include sodium carbonate, sodium bicarbonate, sodium hydroxide, disodium phosphate, trisodium phosphate, sodium borate, aqueous ammonia, sodium trichloroacetate, sodium silicate, and a mixture thereof. Among these compounds, an alkali hydroxide and/or alkali carbonate, particularly sodium hydroxide and/or sodium carbonate are preferred.

Fixation of the dye may be carried out, for example by steam-treating the impregnated fiber material at a temperature of 100 to 120° C., particularly via thermal action such as by saturated steam. According to so-called cold pad-batch method, the dye and alkali metal are introduced to a padder, and they are stored and fixed at room temperature for several hours, for example 3 to 40 hours. After fixation, if desired, a dispersant is added to the resulting dyed product, followed by thorough rinsing.

The dyed product obtained according to the present invention exhibits superior build-up and levelness properties. In addition, the dyed product exhibits high fixability of the dye, capability to easily wash and remove the non-fixed dye, and a small difference between adsorptivity and fixability, that is, a low loss of soap. Further, the dyed product obtained exhibits a high degree of coloration, high stability of fiber-dye bonding, superior fastness against washing, brine, cross-dyeing and sweating, and high fastness against wrinkles, ironing and friction, and particularly superior light fastness.

### EXAMPLES

Now, the present invention will be described in more detail with reference to the following Examples. These examples are provided only for illustrating the present invention and should not be construed as limiting the scope and sprit of the present invention.

### Example 1

51.8 g of a compound of Formula 15 as shown below was dissolved in 500 g of water, and 100 g of ice was added to the resulting solution which was then cooled. 19.0 g of cyanuric chloride was added to the solution and the mixture was stirred and reacted at 5° C. and pH 5 for 2 hours. Thereafter, 22.5 g of 2-aminoethyl-2′-sulfatoethylsulfone was added and condensation was carried out at 30° C. and pH 7.5. 31.0 g of 3-sulfatoethylsulfone-1-aminobenzene was added to the resulting solution and the reaction was completed at 70° C. and pH 2.5. The reaction solution was filtered to remove insoluble materials, followed by salting out using 150 g of sodium chloride. The resulting crystals were dried to obtain 92.5 g of a compound of Formula 16 as shown below:

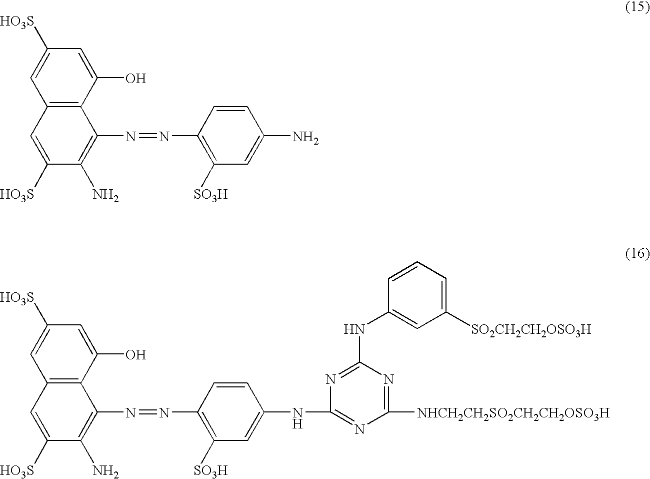

### Example 2

51.8 g of the compound of Formula 15 was dissolved in 500 g of water, and 100 g of ice was added to the resulting solution which was then cooled. 19.0 g of cyanuric chloride was added to the solution and the mixture was stirred to complete the reaction at 5° C. and pH 5 for 2 hours. Thereafter, 22.5 g of 2-aminoethyl-2′-sulfatoethylsulfone was added, and condensation was carried out at 30° C. and pH 7.5. 9.0 g of morpholine was added to the resulting solution and the reaction was completed at 80° C. and pH 9. The reaction solution was filtered to remove insoluble materials, followed by salting out using 130 g of sodium chloride. The resulting crystals were dried to obtain 81.5 g of a compound of Formula 17 as shown below:

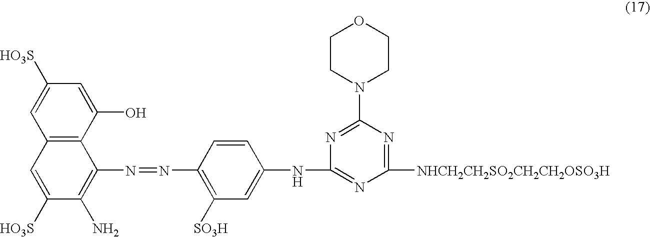

### Example 3

43.8 g of a compound of Formula 18 as shown below was dissolved in 500 g of water, and 100 g of ice was added to the resulting solution which was then cooled. 19.0 g of cyanuric chloride was added to the solution and the mixture was stirred to complete the reaction at 5° C. and pH 5 for 2 hours. Thereafter, 31.3 g of 2-(N-ethylamino)ethyl-2′-sulfatoethylsulfone was added thereto, and condensation was carried out at 25° C. and pH 7.5, thereby completing the reaction. The reaction solution was filtered to remove insoluble materials, and subjected to salting out using 130 g of sodium chloride. The resulting crystals were dried to obtain 83.5 g of a compound of Formula 19 as shown below:

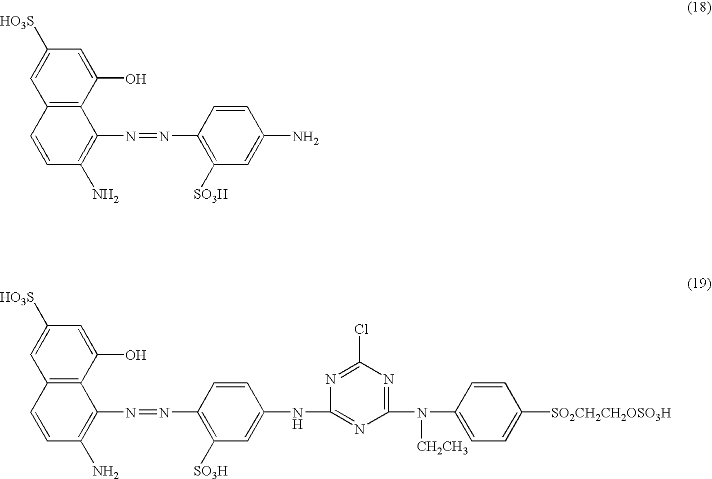

### Examples 4 Through 23

Based on procedures in Examples 1 through 3, it was possible to synthesize compounds listed in Table 1. A specific preparation method of these compounds can be sufficiently deduced through Examples 1 through 3 based on chemical structures of the products, and thus details thereof will be omitted herein.

For convenience to illustrate Table 1, n, X1 and Y1 were indicated in a compound of Formula 20 as shown below:

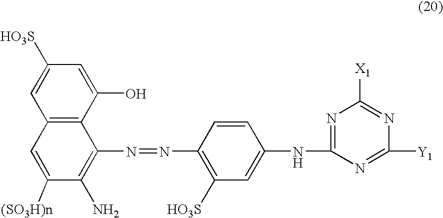

TABLE 1

| | | | | Color of dyed |
|---|---|---|---|---|
| Ex. No. | n | X1 | Y1 | product |
| 4 | 0 | Cl | 4-(2- | Yellowish |
| | | | sulfatoethylsulfonyl)phenylamino | red |
| 5 | 0 | F | 3-(2- | Yellowish |
| | | | sulfatoethylsulfonyl)phenylamino | red |
| 6 | 0 | Cl | N-ethyl-N-(3-(2- | Yellowish |
| | | | sulfatoethylsulfonyl)phenylamino | red |
| 7 | 0 | 3-(2- | 2-(2-sulfatoethylsulfonyl)ethylamino | Red |
| | | sulfatoethylsulfonyl)phenylamino | | |
| 8 | 0 | Morpholino | N-ethyl-N-(3-(2- | Red |
| | | | sulfatoethylsulfonyl)phenylamino | |
| 9 | 0 | Cl | 3-(2- | Yellowish |
| | | | sulfatoethylsulfonyl)phenylamino | red |
| 10 | 0 | 3-(2- | 4-(2- | Red |
| | | sulfatoethylsulfonyl)phenylamino | sulfatoethylsulfonyl)phenylamino | |
| 11 | 0 | Morpholino | N-ethyl-N-(4-(2- | Red |
| | | | sulfatoethylsulfonyl)phenylamino | |
| 12 | 0 | 4-(2- | 3-(2- | Red |
| | | sulfatoethylsulfonyl)phenylamino | sulfatoethylsulfonyl)phenylamino | |
| 13 | 0 | Morpholino | 3-(2- | Red |
| | | | sulfatoethylsulfonyl)phenylamino | |
| 14 | 0 | Cl | 3-(2- | Yellowish |
| | | | sulfatoethylsulfonyl)phenylamino | red |
| 15 | 1 | Cl | 4-(2- | Red |
| | | | sulfatoethylsulfonyl)phenylamino | |
| 16 | 1 | F | N-ethyl-N-(4-(2- | Red |
| | | | sulfatoethylsulfonyl)phenylamino | |
| 17 | 1 | Cl | N-ethyl-N-(3-(2- | Red |
| | | | sulfatoethylsulfonyl)phenylamino | |
| 18 | 1 | 4-(2- | 2-(2-sulfatoethylsulfonyl)ethylamino | Blue red |
| | | sulfatoethylsulfonyl)phenylamino | | |
| 19 | 1 | F | N-ethyl-N-(3-(2- | Red |
| | | | sulfatoethylsulfonyl)phenylamino | |
| 20 | 1 | Cl | 3-(2- | Red |
| | | | sulfatoethylsulfonyl)phenylamino | |
| 21 | 1 | 3-(2- | 4-(2- | Blue red |
| | | sulfatoethylsulfonyl)phenylamino | sulfatoethylsulfonyl)phenylamino | |
| 22 | 1 | Morpholino | N-ethyl-N-(4-(2- | Blue red |
| | | | sulfatoethylsulfonyl)phenylamino | |
| 23 | 1 | 4-(2- | 3-(2- | Blue red |
| | | sulfatoethylsulfonyl)phenylamino | sulfatoethylsulfonyl)phenylamino | |

The compounds of Examples 1 through 23 are dyes having excellent fiber-reactive properties, and combination dyeing using such compounds exhibits superior adsorptivity/fixability and very high light fastness, when dyeing a fiber material containing nitrogen or hydroxyl group. The results of light fastness are shown in Table 2 below.

TABLE 2

| | | | C.I. Reactive | C.I. Reactive |
|---|---|---|---|---|
| | Ex. 1 | Ex. 3 | Red 180 | Red 195 |
| Light fastness | 4˜5 | 4 | 3 | 3 |

### Application Example 1

0.2 g of each compound of Formulae 16, 21 and 22 was dissolved in 400 g of water. The resulting solution was added to 1,500 g of a solution containing 53 g/L of sodium chloride, thereby preparing a dye bath. 100 g of a cotton fabric was added at 40° C. to the dye bath, and 100 g of a solution containing 16 g/L of sodium hydroxide and 20 g of sodium carbonate was added after 45 min. Additionally, the temperature of the dye bath was further maintained at 60° C. for 60 min. Next, the dyed fabric was rinsed, soaped with a nonionic detergent for 25 min upon bubbling, and then rinsed again and dried. The dyed product thus obtained exhibited very high light fastness.

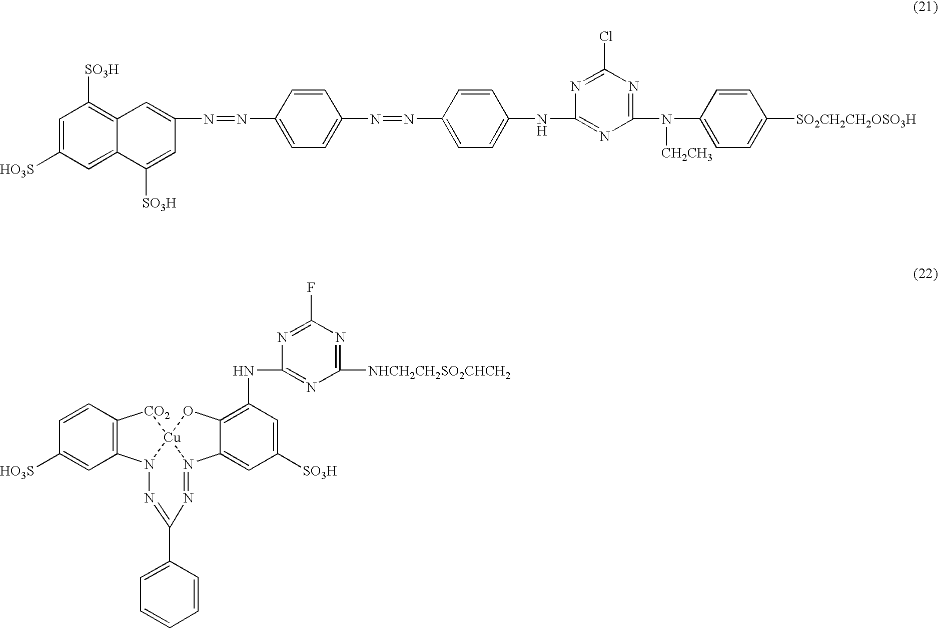

### Application Example 2

0.3 g of each compound of Formulae 17, 23 and 24 was dissolved in 400 g of water. The resulting solution was added to 1,500 g of a solution containing 16 g/L of sodium hydroxide, thereby preparing a dye bath. 100 g of a cotton fabric was padded at 25° C. in the dye bath, and was wound on a padding roll and stored at room temperature for 1 hour. Next, the dyed fabric was rinsed, soaped with a nonionic detergent for 25 min upon bubbling, and then rinsed again and dried. The dyed product thus obtained exhibited excellent wash fastness and particularly very high light fastness.

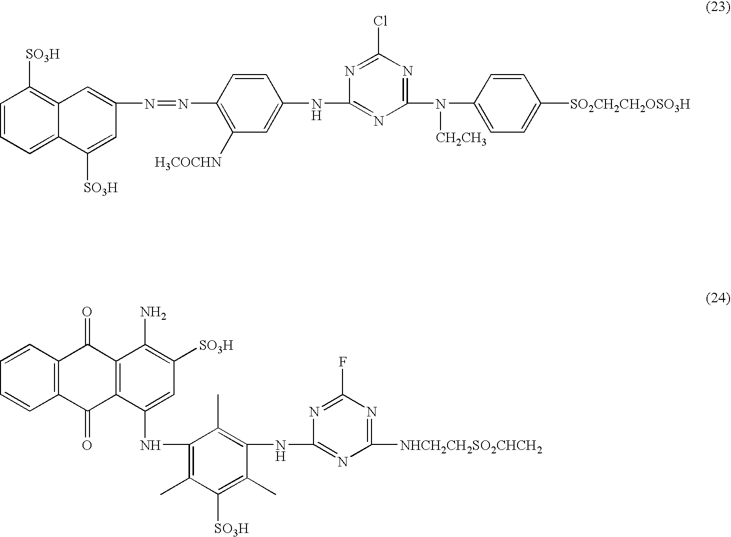

### Application Example 3

0.1 g of each compound of Formulae 17, 25 and 26 was dissolved in 400 g of water. The resulting solution was added to 1,500 g of a solution containing 53 g/L of sodium chloride, thereby preparing a dye bath. 100 g of a cotton fabric was added at 40° C. to the dye bath, and 100 g of a solution containing 16 g/L of sodium hydroxide and 20 g of sodium carbonate was added after 45 min. Additionally, the temperature of the dye bath was further maintained at 60° C. for 60 min. Next, the dyed fabric was rinsed, soaped with a nonionic detergent for 25 min upon bubbling, and then rinsed again and dried. The dyed product thus obtained exhibited excellent wash fastness and particularly very high light fastness.

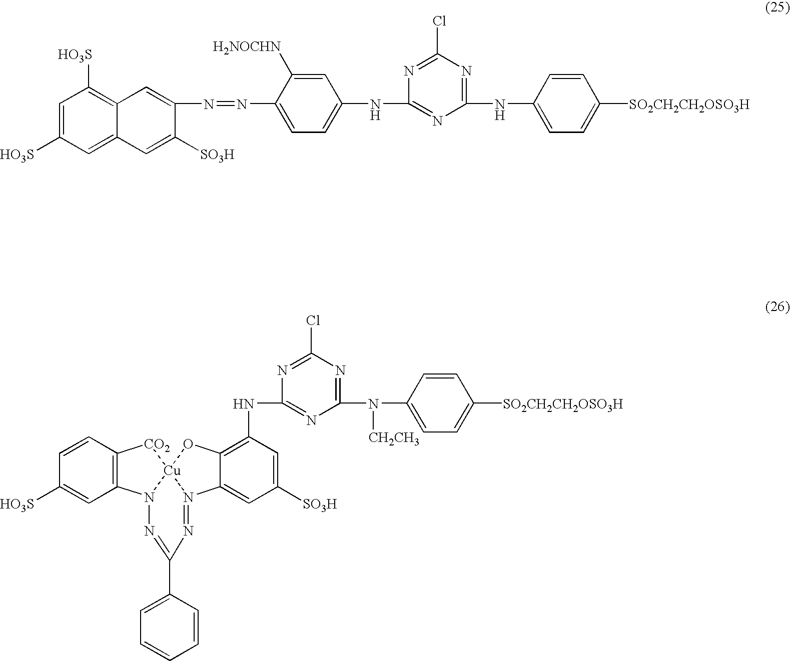

Based on procedures in previous Examples, it is possible to make an appropriate combination of the reactive dye compounds given in Examples 1 through 23. A variety of other mixing ratios can also be sufficiently deduced by those of ordinary skill in the art and thus details thereof will be omitted herein.

### Comparative Example 1

0.1 g of each compound of C.I. Reactive Red 180, and Formulae 27 and 28 was dissolved in 400 g of water. The resulting solution was added to 1,500 g of a solution containing 53 g/L of sodium chloride, thereby preparing a dye bath. 100 g of a cotton fabric was added at 40° C. to the dye bath, and 100 g of a solution containing 16 g/L of sodium hydroxide and 20 g of sodium carbonate was added after 45 min. Additionally, the temperature of the dye bath was further maintained at 60° C. for 60 min. Next, the dyed fabric was rinsed, soaped with a nonionic detergent for 25 min upon bubbling, and then rinsed again and dried, thereby obtaining the dyed product.

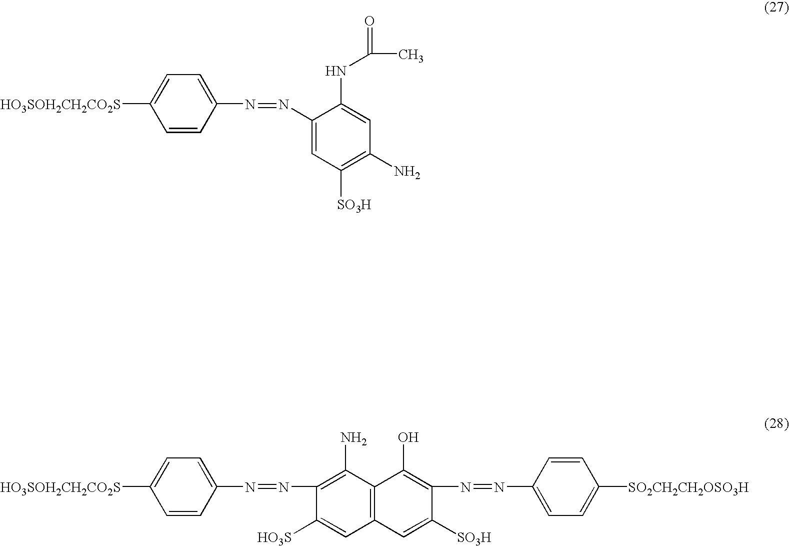

### Comparative Example 2

0.1 g of each compound of C.I. Reactive Red 195, and Formulae 24 and 29 was dissolved in 400 g of water. The resulting solution was added to 1,500 g of a solution containing 53 g/L of sodium chloride, thereby preparing a dye bath. 100 g of a cotton fabric was added at 40° C. to the dye bath, and 100 g of a solution containing 16 g/L of sodium hydroxide and 20 g of sodium carbonate was added after 45 min. Additionally, the temperature of the dye bath was further maintained at 60° C. for 60 min. Next, the dyed fabric was rinsed, soaped with a nonionic detergent for 25 min upon bubbling, and then rinsed again and dried, thereby obtaining the dyed product.

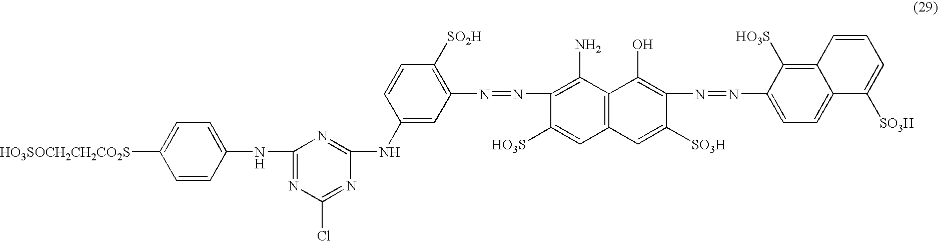

### Comparative Example 3

0.1 g of each compound of C.I. Reactive Red 195, and Formulae 25 and 26 was dissolved in 400 g of water. The resulting solution was added to 1,500 g of a solution containing 53 g/L of sodium chloride, thereby preparing a dye bath. 100 g of a cotton fabric was added at 40° C. to the dye bath, and 100 g of a solution containing 16 g/L of sodium hydroxide and 20 g of sodium carbonate was added after 45 min. Additionally, the temperature of the dye bath was further maintained at 60° C. for 60 min. Next, the dyed fabric was rinsed, soaped with a nonionic detergent for 25 min upon bubbling, and then rinsed again and dried, thereby obtaining the dyed product.

Light fastness of the dyed products obtained in Application Examples 1 through 3 and Comparative Examples 1 through 3 was measured according to an AATCC 16E test method. The results thus obtained are shown in Table 3 below.

TABLE 3

| | Appl. | Appl. | Comp. | Comp. | Comp. |
|---|---|---|---|---|---|
| | Ex. 1 | Ex. 3 | Ex. 1 | Ex. 2 | Ex. 3 |
| Light | 4˜5 | 4 | 2 | 2˜3 | 3 |
| fastness | | | | | |
| Decol- | Uniform | Uniform | Uniform | Nonuniform | Nonuniform |
| oration | | | | | |

As apparent from the above description, fiber products using the fiber-reactive dye composition in accordance with the present invention exhibit superior adsorptivity and fixability, upon dyeing a fiber material, particularly a cellulose fiber material by a conventional fixation method, and display very high fastness against light and wet treatment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A dye composition, comprising
(i) a reactive red dye represented by Formula 1;
(ii) one or more reactive dyes selected from the group consisting of a reactive yellow dye represented by Formula 2, a reactive orange dye represented by Formula 3 and a mixture thereof; and
(iii) one or more reactive dyes selected from the group consisting of a reactive blue dye represented by Formula 4, a reactive blue dye represented by Formula 5 and a mixture thereof: 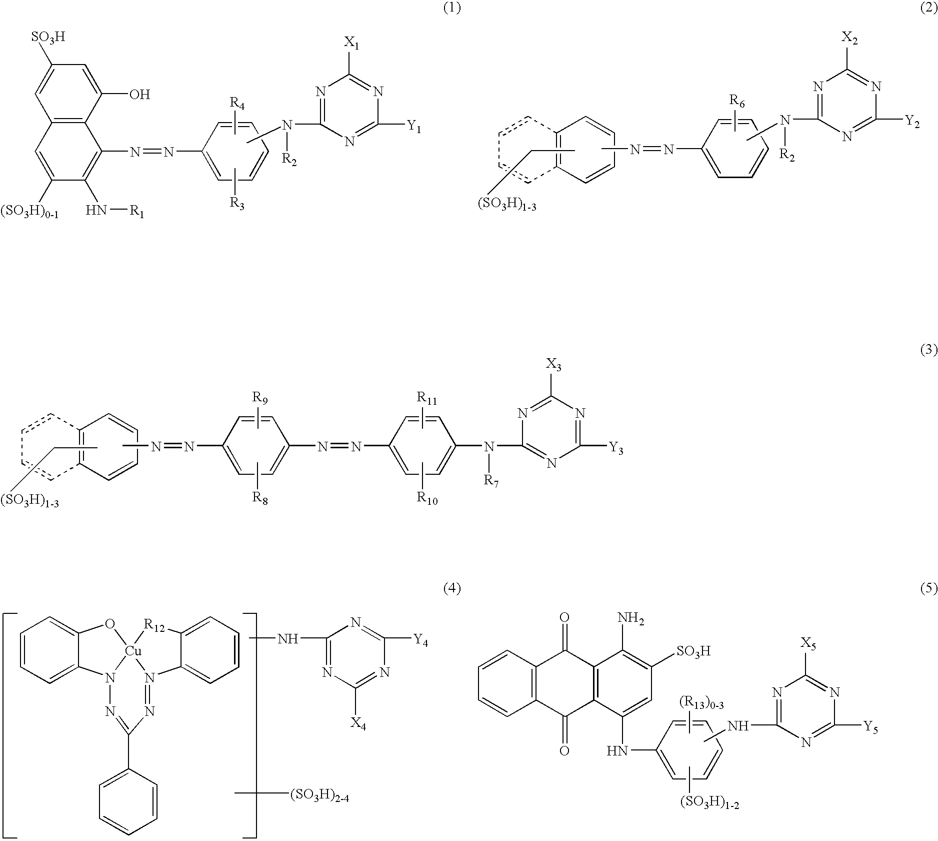
wherein:
R1, R2, R5 and R7 are independently hydrogen, or C1-C4 alkyl which may be substituted or unsubstituted with hydroxyl, sulfo, sulfato or carboxyl group;
R3, R4, R6, R8, R9, R10, R11 and R13 are independenty hydrogen, C1-C4 alkyl, C1-C4 alkoxy, C2-C4 alkanoylamino, ureido, sulfamoyl, halogen, sulfo or carboxyl group;
R12 is hydroxyl, sulfo or carboxyl group;
Y1, Y2, Y3, Y4 and Y5 are independently a substituent group of Formula 6a, 6b or 6c: 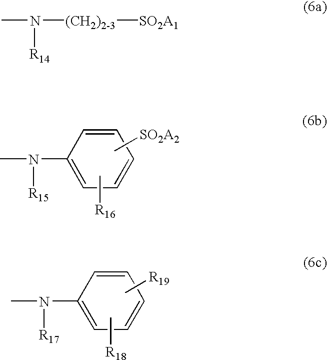
wherein R14, R15 and R17 are independently hydrogen, or C1-C4 alkyl which may be substituted or unsubstituted with hydroxyl, sulfo, sulfato or carboxyl group; R16, R18 and R19 are independently hydrogen, C1-C4 alkyl, C1-C4 alkoxy, C2-C4 alkanoylamino, ureido, sulfamoyl, halogen, sulfo or carboxyl group; A1 and A2 are independently a vinyl group or a radical of —CH2-CH2-Q, wherein Q is a leaving group that can be removed under alkaline conditions, for example —Cl, —Br, —F, —OSO3H, —SSO3H, —OCO—CH3, —OPO3H2, —OCO—C6H5, —OSO2-C1-C4 alkyl or —OSO2N(C1-C4 alkyl), preferably —OSO3H; and
X1, X2, X3, X4 and X5 are independently a substituent group of Formula 6a, 6b or 6c, which is an N-heterocyclic group capable of further containing halogen, hydroxyl, 3-carboxypyridin-1-yl, 3-carbamoylpyridin-1-yl, C1-C4 alkoxy group, C1-C4 alkylthio group, unsubstituted or substituted amino group, or a hetero atom.

2. The composition according to claim 1, wherein X2 to X5 are fluorine or chlorine.

3. The composition according to claim 1, wherein the reactive red dye of Formula 1 is a compound represented by Formula 7: 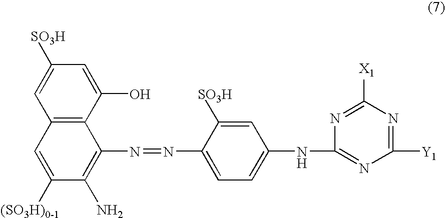
wherein X1 and Y1 are as defined in Formula 1.

4. The composition according to claim 1, wherein the reactive red dye of Formula 1 is a compound represented by Formula 8: 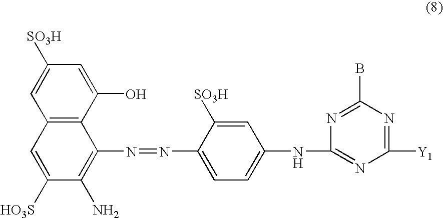
wherein B is a substituent group of Formula 6a, 6b or 6c, provided that fluorine and chlorine are excluded, and
Y1 is as defined in Formula 1.

5. The composition according to claim 1, wherein the reactive red dye of Formula 1 is a compound represented by Formula 9: 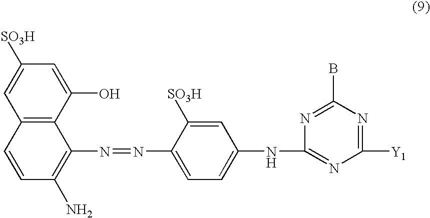
wherein B is a substituent group of Formula 6a, 6b or 6c, provided that fluorine and chlorine are excluded, and
Y1 is as defined in Formula 1.

6. The composition according to claim 1, wherein the dye composition optionally includes a compound of Formula 14: 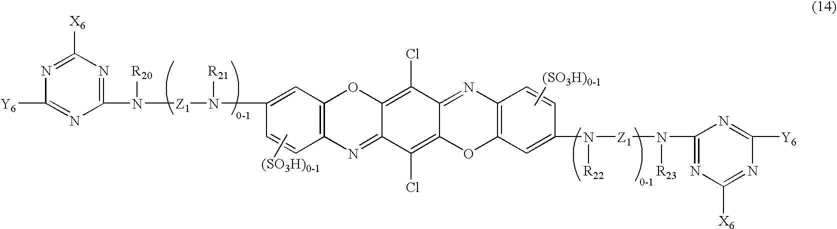
wherein R20, R21, R22 and R23 are independently hydrogen, or C1-C4 alkyl which may be substituted or unsubstituted with hydroxyl, sulfo, sulfato or carboxyl group;
Y6 is a substituent group of Formula 6a, 6b or 6c;
X6 is a substituent group of Formula 6a, 6b or 6c, which is an N-heterocyclic group capable of further containing halogen, hydroxyl, 3-carboxypyridin-1-yl, 3-carbamoylpyridin-1-yl, C1-C4 alkoxy group, C1-C4 alkylthio group, unsubstituted or substituted amino group, or a hetero atom; and
Z1 and Z2 are independently unsubstituted or substituted C2-C10 alkylene.

7. A method of dyeing a fiber material containing nitrogen or hydroxyl group using the dye composition according to claims 1.

8. The composition according to claim 2, wherein the reactive red dye of Formula 1 is a compound represented by Formula 7: 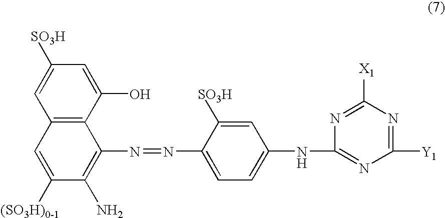
wherein X1 and Y1 are as defined in Formula 1.

9. The composition according to claim 2, wherein the reactive red dye of Formula 1 is a compound represented by Formula 8: 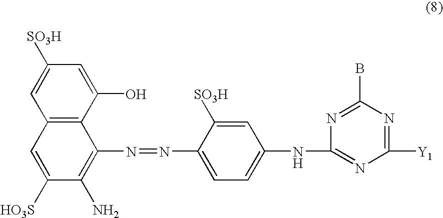
wherein B is a substituent group of Formula 6a, 6b or 6c, provided that fluorine and chlorine are excluded, and
Y1 is as defined in Formula 1.

10. The composition according to claim 2, wherein the reactive red dye of Formula 1 is a compound represented by Formula 9: 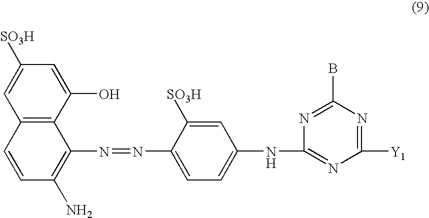
wherein B is a substituent group of Formula 6a, 6b or 6c, provided that fluorine and chlorine are excluded, and
Y1 is as defined in Formula 1.
